(19) United States
(12) Patent Application Publication
(10) Pub. No.: US 2005/0237440 A1
(43) Pub. Date: Oct. 27, 2005

(54) Method and device to enhance the readability of a liquid crystal display through polarized lenses

(75) Inventors: Hideyo Sugimura, North Oaks, MN (US); Xuzhi Qin, Hacienda Heights, CA (US)

Correspondence Address: INSKEEP INTELLECTUAL PROPERTY GROUP, INC, 2281 W. 190TH STREET, SUITE 200, TORRANCE, CA, 90504, US

(73) Assignee: Vision-Ease Lens

(21) Appl. No.: 11/082,605

(22) Filed: Mar. 16, 2005

Related U.S. Application Data
(60) Provisional application No. 60/553,649, filed on Mar. 16, 2004.

(51) Int. Cl. G02F 1/1335

(52) U.S. Cl. 349/13

(57) ABSTRACT

An optical film is placed over a liquid crystal display to manipulate the polarized light exiting the top polarizing layer of the display such that the light is less likely to become blocked out by the polarized sunglasses of a user viewing the device. The manipulation may include retarding the axis of the light or diffusing the light.

### RELATED APPLICATIONS

This application claims priority to U.S. Provisional Application Ser. No. 60/553,649, entitled Method To Enhance The Readability of LCD Display Through Polarized Lenses, filed on Mar. 16, 2004, and incorporated in its entirety herein.

### BACKGROUND

Polarizing is a process by which extremely tiny parallel lines of dye are created on a transparent substrate, such as a lens, crystal or sheet. These tiny lines block light rays that are not aligned with the lines. Light rays travel in a sinusoidal pattern. The oscillations are planar but each ray may oscillate in a different plane. Thus, polarized substrates block all rays that are not oscillating in a plane that is substantially parallel to the direction of the polarized lines.

Polarized substrates have a variety of uses. For example, polarized sunglasses are popular because they filter glare from horizontal surfaces such as roads and lakes. Reflected light tends to oscillate in planes that coincide with the reflecting surfaces. Because the light reflected from lakes and roads are necessarily horizontal, polarized sunglasses are created with vertical polarizing axes.

Polarization has also made liquid crystal displays (LCDs) possible. LCDs use a pair of polarized lenses separated by a liquid crystal sealed therebetween. The liquid crystal contains molecules that respond to applied voltage by aligning. The LCDs are arranged such that their polarization axes are perpendicular to each other. When no charge is applied across the liquid crystal, the molecules act to bend light passing through the liquid ninety degrees (90°). Thus, unorganized incident light strikes the first polarized lens and is filtered such that the light rays passing through all oscillate in parallel planes. As the light continues through the liquid crystal, it bends ninety degrees and, by the time it reaches the second polarized plate, is aligned with the polarization axis of the second plate. Thus, the light rays can pass unobstructed through the second plate.

When voltage is applied, the liquid crystal molecules align and no longer bend the light. Thus, the light becomes blocked by the second polarized plate because the light rays are oscillating planes that are perpendicular to the polarization axis of the second plate. By selectively applying voltage to various LCD cells, symbols may be formed and the LCD becomes readable by a user.

Both of the aforementioned uses for polarizing technology have been significant technological advances. Ironically, these uses can conflict with each other. Because the light passing through an LCD has been filtered by a polarized substrate, it is vulnerable to being completely blocked by a pair of polarized sunglasses. In other words, if a person is wearing a pair of polarized sunglasses, they may be unable to see an LCD. Because LCDs are used in a wide variety of applications, e.g. cellular telephones, calculators, watches, televisions, computers, etc., the chance of interference while wearing polarized sunglasses is significant. For example, many automobiles are now equipped with LCD global positioning and onboard computer displays. If the polarization axis of the outermost polarizing plate of the LCD is horizontal, a driver would be unable to see the display while wearing vertically polarized sunglasses. If the difference in polarization axis angles between the glasses and the LCD is between zero and ninety degrees, the driver's ability to see the display is degraded proportionately. This problem could be potentially dangerous if the operator of a vehicle misses an important indication on the LCD.

Typically, LCDs are constructed with upper polarizing plates that are oriented at an angle other than horizontal for this very reason. However, unless the polarization axes of both the sunglasses and the LCD are parallel, there will be a degree of degradation. Additionally, with an LCD polarization angle of between zero and ninety degrees, complete blockage by a sunglass user with his or her head tilted becomes more likely. There is always a position at which the LCD display will be blacked out for a viewer wearing a pair of polarized sunglasses. There is thus a need for a treatment, film, or the like that can be applied to the surface of an LCD that prevents this degradation.

### SUMMARY OF THE INVENTION

In order to address the aforementioned need, the present invention pertains to a method of enhancing the readability of an LCD when viewed through a pair of polarized sunglasses, by placing an optical film at a certain orientation to disturb the polarized light out of the LCD. This invention also relates to a polarizing plate comprising such an optical film on one side of the polarizing film with a certain orientation. This invention further relates to an LCD setup that has such an optical film on top with a certain orientation, or an LCD setup that uses the inventive polarizing plate as the top polarizer covered with the optical film facing of the present invention. The method of this invention can be advantageously used to improve the readability of LCDs such as those in automobile dash displays, cellular phones, and flat panel screens, and avoid total blackout of the display when viewed through polarized lenses.

Thus, it is the object of this invention to provide a method to enhance the readability (view-ability) of an LCD that has a front polarizer when the LCD is viewed through polarized lenses.

The object is realized by placing an optical film between the LCD and the polarized lens wherein the optical film will alter the polarized light out of the LCD so that it will not be blocked by the polarized lenses used by the viewer. At the same, the optical film will not have any effect under the normal viewing situation in which polarized lenses are not worn.

The method of this invention can be conveniently used to improve the readability of any LCD that uses a front polarizer. Examples include LCD gauges in automobiles, LCDs of cellular phones, and LCD flat panels.

The terminology “film” as used herein embraces not only films in a strict sense but plates or sheets or laminates having a thickness of, for example, between 0.05 mm and 1 mm.

### BRIEF DESCRIPTION OF THE DRAWINGS

FIG. 1 shows a typical layer structure of a transflective LCD;

FIG. 2 shows the transfiective LCD modified according to the present invention;

FIG. 3 shows the relative directions of the polarizing axis of the LCD polarized light, the optical axis (one of the primary optical axes) of a retardation film, and the polarizing axis of the polarized lens;

FIG. 4 is a sectional view of an embodiment of the optical film of the present invention;

FIGS. 5-6 demonstrate the effect of a retardation film of the present invention on a cellular phone LCD when viewed through a pair of polarized sunglasses.

### DETAILED DESCRIPTION OF THE INVENTION

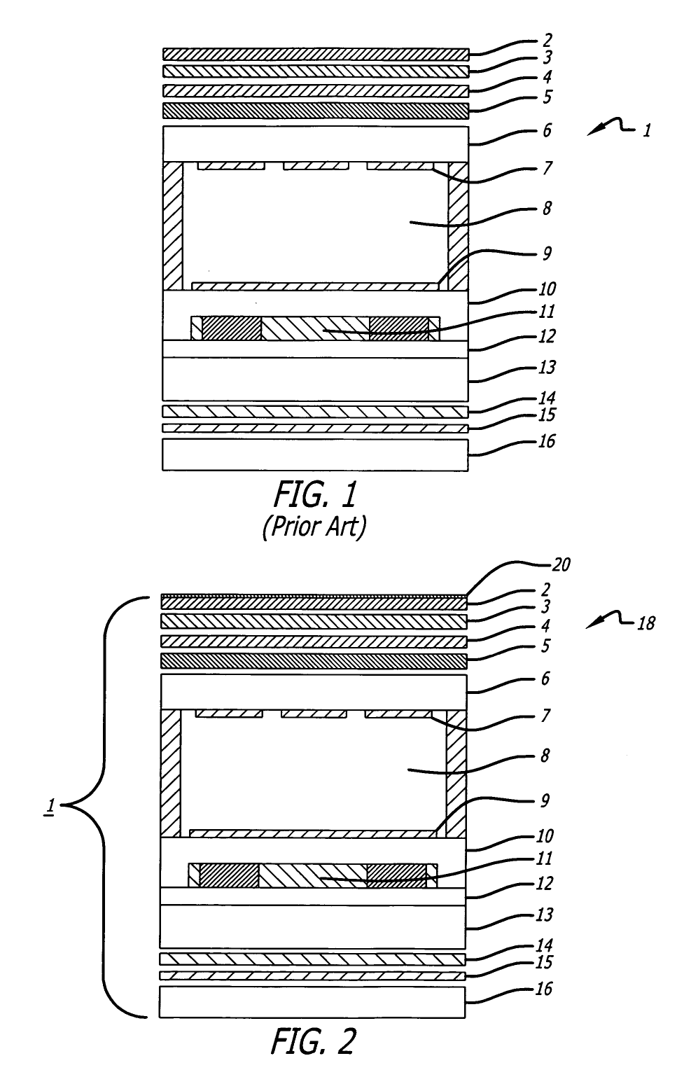

Referring now to the figures, and first to FIG. 1, there is shown a typical design of a transflective, color LCD 1. Above the liquid crystal, the LCD 1 includes a top polarizer 2, a retardation film 3, another retardation film 4, a scattering film 5, and a sheet of top glass 6. The top glass 6 defines the upper extent of the liquid crystal compartment. Column electrodes 7 are found on the bottom surface of the top glass 6, while row electrodes 9 are found opposite the column electrodes 7. Liquid crystal 8 separates the column electrodes 7 from the row electrodes 9. A sheet of bottom glass 13 is used as a foundation for the bottom of the liquid crystal compartment. The bottom glass 13 is topped by a half mirror 12 and a color filter 11. The color filter 11 is protected with an overcoating 9 onto which the row electrodes are attached. Because a transflective LCD may receive its incident light from above or below, a retardation film 14 and a bottom polarizer 15 are found below the bottom glass 13. Finally, a backlight system 16 comprises the bottom layer of the LCD.

FIG. 2 shows an LCD 18 of the present invention. The LCD 18 comprises any LCD 1 with an optical film 20 applied to the top surface of the top polarizer 2. The LCD 18 may be formed with any existing LCD. The LCD 1 shown in FIGS. 1 and 2 is merely provided by way of example.

The optical film 20 can either be a simple phase retardation film or a composite element that comprises more than one layer of retardation film. An example of the later is a de-polarizer or polarizing light scrambler of Lyot type.

The optical film 20 is placed above the polarizer plate 2, thereby positioning it between the LCD and the polarized sunglass lenses of the viewer. The optical axis of the optical film is neither parallel nor perpendicular to the polarizing direction of the LCD 1. In a preferred embodiment, the angle between the optical axis of the film and the polarizing direction is set so as to give the maximum light intensity when viewed through a polarized lens that has a vertical polarizing direction. A preferred angle is 45°.

The optical film 20 may be a simple phase retardation film. If so, an acceptable phase shift is between π/8 and 15 π/8. If the phase shift (retardation) is π, the film is a half-wave (π/2) retarder. The linearly polarized light out of the LCD will be simply rotated by an angle. The polarization direction of the emergent light is preferably vertical for maximum transmission through vertically polarized sunglasses. All other phase shifts will generate an elliptically polarized light and the retardation film should be aligned so that the long axis of the ellipse is vertical. A special case is the circular polarized light generated by a π/2 phase shift (π/4 retarder).

Because polarized sheets are produced by stretching a substrate, the polarization direction is always parallel to the longitudinal edges of the substrate. Thus, cutting polarized plates for use with LCDs at an angle results in significant waste. The method of the present invention makes it no longer necessary to cut the polarizing plates at an angle, thereby eliminating this waste.

The optical phase retardation film 20 has a retardation value expressed by the following equation:
δ=Δn·d
where Δn is the refractive index difference between the two principle optical axis in the plane perpendicular to the light path, and d is the film thickness.

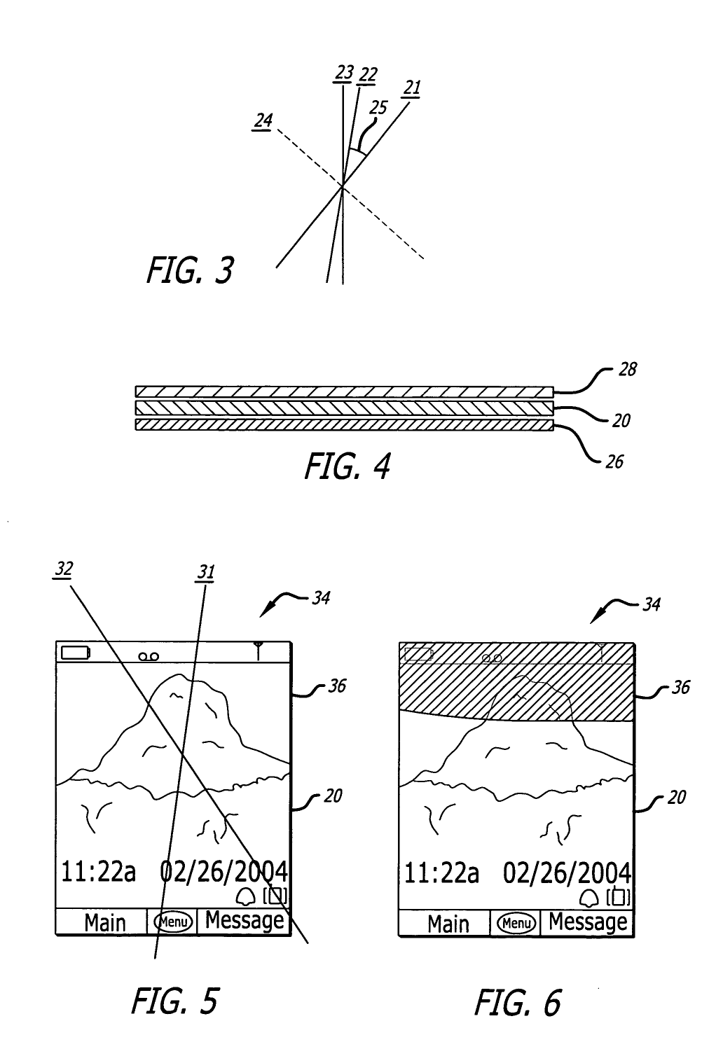

Referring to FIGS. 2 and 3, the retardation film 20 is placed between the LCD 1 and the polarized sunglass lens (not shown). The optical axis 22 of the retardation film is neither parallel nor perpendicular to the polarization direction 21 of the LCD's polarized light. The angle 25 between the optical axis 22 and the polarization direction 21 is set so that the light intensity passing through the polarized lens with a vertical polarization direction 23 is maximized. The angle 25 is preferably on the order of 45°. The phase retardation can be either zero order or multi-wave. The retardation value is larger than 20 nm, preferably >100 nm.

Considering the ease of application, the phase retardation film 20 is preferably made of thermoplastic resin. Other materials such as mica may also be used. The thermoplastic resin which can be used for the retardation films of the present invention includes polycarbonate resins; methacrylate resins, such as polymethyl methacrylate and methyl methacrylate copolymers comprising methyl methacrylate as a main component and other ethylenic comonomers; styrene resins, such as polystyrene, styrene-acrylonitrile copolymers, styrene-methyl methacrylate copolymers, and styrene copolymers comprising styrene as a main component and other ethylenic comonomers; α-methylstyrene polymer resins, such as an α-methylstyrene homopolymer, α-methylstyrene-acrylonitrile copolymers, and α-methylstyrene copolymers comprising α-methylstyrene as a main component and other ethylenic comonomers; acrylonitrile resins, such as polyacrylonitrile and acrylonitrile copolymers; polyester resins, such as polyethylene terephthalate and polyester copolymers; polyamide resins, such as nylon 6 and nylon 66; vinyl chloride resins, such as polyvinyl chloride and vinyl chloride copolymers; polyolefin resins, such as polyethylene, polypropylene, ethylene copolymers, and propylene copolymers; polysulfone, polyether sulfone, fluorine-containing resins such as chlorotrifluoroethylene-containing, etc. and modified resins thereof; polyarylate resins; polyvinal alcohol; and a blend of any of these resins and a transparent low-molecular weight compound (e.g., high-molecular weight liquid crystals and low-molecular weight liquid crystals). These resins may be used either individually or as a mixture of two or more thereof.

Liquid Crystal Polymers (LCP) can be used to make the phase retardation film 20. LCPs are a class of polymers wherein liquid crystal monomers are incorporated into the macromolecular structure along the main chain (backbone) or as side chain units. LCP films, particularly UV cross-linkable polymer nematic retarders, are particularly suitable for forming retarders. An attractive feature is the ability to produce thin retarders as the material can have high birefringence relative to stretched materials. This permits the fabrication of multi-layer retarder stacks on a single substrate with low cost. Because the films can be patterned at arbitrary angles, there is no waste, as is the case when cutting stretched polymer films at angles. Each LCP layer can essentially be bonded to the previous layer, avoiding the need for applying pressure sensitive adhesives to each film.

A monochromic retardation film with a particular retardation at the design wavelength will have greater retardation at shorter wavelengths and less retardation at longer wavelengths. Color variation is introduced when viewing through a polarized lens.

Broadband or achromatic retardation films are also desirable. For example, a broadband ¼ retardation plate can be constructed with ½ and ¼ retardation films. Broadband ¼ plates are also disclosed in patents such as U.S. Pat. Nos. 6,593,984 and 6,638,582, hereby incorporated in their entireties.

One embodiment of the present invention provides, as an optical film 20, a light diffusion sheet rather than a retardation film. Light diffusion sheets take organized, polarized light rays and diffuse them creating disorganized light rays. Though typically not as clear as a ¼ wavelength film or plate, diffusion sheets have no optical axes and can therefore be applied easily without regard to orientation.

In one embodiment of the present invention, shown in FIG. 4 a retardation film 20 is prepared with an adhesive layer 26 so that it can be easily fixed to an existing LCD to enhance its readability through a polarized lens. Additional, optional functional layers 28 may also be added such as an anti-reflective layer, scratch-resistant hardcoat, and the like, laminated onto the retardation film 20. Alternatively, the retardation film 20 may be laminated directly onto the top polarizing plate 2 of an LCD 1.

In another embodiment of the present invention, a retardation film is laminated to a polarizing film to act as a protective layer.

The aforementioned polarizing plates can be used to replace conventional polarizing plates used in LCDs so long as the retardation film faces the viewer.

### EXAMPLE

Referring to FIGS. 5 and 6, a retardation film 20 of the present invention has been constructed of polycarbonate and has a retardation value of 135 nm. The retardation film 20 was placed on a bottom portion of the LCD display 34 of a cellular telephone. The polarized light out of the LCD 34 has a polarization direction 31 about 150 off the vertical direction. The optical axis 32 of the retardation film 20 forms a 45° angle with the LCD's polarized light. FIG. 5 shows that the film 20 is virtually invisible to the naked eye, as compared to the area 36 on the LCD 34 that is not covered by the film 20. FIG. 6 shows the film as viewed through polarized glasses. It is readily apparent that the retardation film 20 eliminates the possibility of blackout of the display in the regions where the retardation film is affixed to the LCD when viewed through a pair of polarized sunglasses, regardless of the polarizing direction of the polarized lenses.

1. An LCD system comprising:
an LCD with a polarizing layer;
an optical film disposed above said polarizing layer so as to substantially prevent viewing of a blacked out condition of said LCD when viewed by a user through polarized sunglasses.

2. The LCD system of claim 1 wherein said optical film has a predetermined retardation value greater than 20 nm.

3. The LCD system of claim 2 wherein said predetermined retardation value is greater than 100 nm.

4. The LCD system of claim 1 wherein the optical film comprises thermoplastic resin.

5. The LCD system of claim 1 wherein the polarizing layer of the LCD has a polarization axis and the optical film has an optical axis that is neither parallel nor perpendicular to the polarization axis.

6. The LCD system of claim 5 wherein an angle between the polarization axis and the optical axis is selected to maximize the light passing through a vertically polarized sunglass lens worn by a person viewing of the LCD system.

7. The LCD system of claim 5 wherein the angle between the polarization axis and the optical axis is on the order of 45 degrees.

8. The LCD system of claim 1 wherein the optical film comprises a liquid crystal polymer.

9. The LCD system of claim 1 wherein the optical film comprises a retardation film.

10. The LCD system of claim 1 further comprising an adhesive layer attaching the optical film to the LCD.

11. The LCD system of claim 1 wherein the optical film comprises a retardation layer and a functional layer operably disposed above the retardation layer.

12. The LCD system of claim 1 wherein the optical film comprises a light diffusion sheet.

13. The LCD system of claim 1 wherein said optical film has a retardation value of π/4 wavelength.

14. The LCD system of claim 13 wherein said optical film comprises a broadband % wavelength film.

15. The LCD system of claim 13 wherein said optical film comprises a broadband % wavelength plate.

16. A method of improving the visibility of an LCD by a user wearing polarized sunglasses comprising disposing an optical film above a polarizing layer of the LCD so as to substantially prevent viewing a blacked out condition by said user.

17. The method of claim 16 wherein disposing an optical film above a polarizing layer of the LCD comprises disposing an optical film having a predetermined retardation value greater than 20 nm.

18. The method of claim 17 wherein disposing an optical film having a predetermined retardation value greater than 20 nm above the polarizing layer of the LCD comprises disposing an optical film having a predetermined retardation value greater than 100 nm above the polarizing layer of the LCD.

19. The method of claim 16 wherein disposing an optical film above a polarizing layer of the LCD comprises disposing a film of thermoplastic resin above the polarizing layer of the LCD.

20. The method of claim 16 wherein disposing an optical film above a polarizing layer of the LCD comprises disposing an optical film above the polarizing layer of the LCD such that a polarization axis of the polarizing layer and an optical axis of the optical film are neither parallel nor perpendicular to each other.

21. The method of claim 20 wherein disposing an optical film above the polarizing layer of the LCD such that a polarization axis of the polarizing layer and an optical axis of the optical film are neither parallel nor perpendicular to each other comprises selecting an angle between the polarization axis and the optical axis to maximize the light passing through a vertically polarized sunglass lens worn by the user viewing the LCD system.

22. An LCD system comprising:
an LCD having a polarizing layer disposed between liquid crystal and a user, the polarizing layer causing light viewed by the user to be oriented along a polarization axis;
an optical film disposed between the polarizing layer and the user such that the oriented light passing through the optical film from the polarizing layer is manipulated such that at least a portion of the light is no longer oriented along the polarization axis, thereby preventing the user from being unable to see the light when wearing vertically polarized sunglasses.

23. The LCD system of claim 22 wherein said optical film has a predetermined retardation value greater than 20 nm.

24. An LCD comprising:
a bottom polarizing plate having an axis of polarization that is substantially parallel to an edge of the bottom polarizing plate;
a top polarizing plate having an axis of polarization that is substantially parallel to an edge of the top polarizing plate;
liquid crystal disposed between the top and bottom polarizing plates;
a set of electrodes constructed and arranged to generate an electrical potential across the liquid crystal; a retardation layer disposed above the top polarizing plate.

25. A method of transmitting light in a liquid crystal display comprising:
allowing light to propagate through a liquid crystal array in said display;
directing said light from said liquid crystal array towards a human viewer;
polarizing said light prior to said light reaching said human viewer;
retarding said polarized light prior to said light reaching said human viewer such that a substantial portion of said light is visable to said viewer at all times in the event said viewer is wearing a polarized lens.

26. A method according to claim 25, wherein the polarizing of said light includes transmitting said light through a polarization layer having an optical axis that is substantially parallel to an edge of said display.

27. A method according to claim 25, wherein the retarding of said polarized light includes transmitting said polarized light through a retardation layer.

28. A method according to claim 27, wherein the transmitting of said polarized light through a retardation layer includes transmitting light through a retardation layer whose optical access is out of alignment with an axis of said polarized light.
